(19) United States
(12) Patent Application Publication
(10) Pub. No.: US 2010/0115435 A1
(43) Pub. Date: May 6, 2010

(54) Extended classification space and color model for the classification and display of multi-parameter data sets

(76) Inventor: Ronald Aaron Mickaels, Pleasanton, CA (US)

Correspondence Address: Leukobyte Inc., 1987 Foxswallow Cir., Pleasanton, CA, 94566, US

(21) Appl. No.: 12/587,543

(22) Filed: Oct. 8, 2009

Related U.S. Application Data
(60) Provisional application No. 61/195,726, filed on Oct. 10, 2008.

(51) Int. Cl. G06F 3/048

(52) U.S. Cl. 715/763

(57) ABSTRACT

The invention pertains to the user-directed classification of multi-parameter data streams with a computer program that allows users to “paint” events in one of several linked n-dimensional views of the data set. The events that are painted in one view of the data are also painted with the same color in the other views. By combining primary colors with multiple paint operations, individual data clusters can be identified by the user.

A limited solution was taught by Conrad, et al. that allowed the binary addition of primary colors in the paint operations and allowed the identification of only eight unique populations.

The present invention extends the solution by allowing multiple effective paint operations with the primary colors thus allowing the identification of an almost limitless number of unique populations. A logical and predictable progression of resultant colors is maintained for data display to the user.

### CROSS-REFERENCE TO RELATED APPLICATIONS

This application is filed pursuant to U.S. Provisional Patent Application 61/195,726 filed Oct. 10, 2008

### TECHNICAL FIELD

The invention pertains to the field of scientific data analysis, specifically the need to classify multidimensional datasets into populations of similar data points.

The invention should be understandable to someone practiced in the arts of multidimensional data analysis, software algorithms, graphical user interface design and colorimetry.

### STATEMENT REGARDING FEDERALLY SPONSORED RESEARCH OR DEVELOPMENT

None of the inventive work being applied for herein was sponsored by the U.S. Government.

### BACKGROUND ART

U.S. Pat. No. 4,845,653 (“Method of displaying multi-parameter data sets to aid in the analysis of data characteristics”, Conrad, et al.) describes a method for classification of multi-parameter data whereby a computer program can be used to show multiple linked n-dimensional views of the data set, and to allow an operator to “paint” events in one of the views of the data with a color in order to classify them. The events that are painted in one view of the data are also painted with the same color in the other views.

The prior art invention further describes a method for handling events that have been painted with more than one color:
“Rather, the different color regions may overlap so that one or more data events may have a combination of colors. For example, if the three colors of red, blue and green are used to color data events, some dots may appear as yellow (red/green) other dots as cyan (blue/green) and other dots as violet (red/blue). If all three colors are associated with data events, the combined color appears as white. Therefore, if three initial colors are chosen to select different regions of data events, a total of seven different color combinations may be viewed by the user in the discrimination of cell types or cell subpopulations or other characteristics thereof.”

The method described in the prior art invention as a “combination of colors” is, in fact, a combination of colors in the standard RGB Color Model. A large percentage of the visible spectrum can be represented by mixing red, green, and blue (RGB) colored light in various proportions and intensities. Where the colors overlap, they create cyan, magenta, yellow, and white.

RGB colors are called additive colors because you create white by adding R, G, and B together. Your monitor, for example, creates color by emitting light through red, green, and blue phosphors. See FIG. 1.

A standard for the RGB color model denotes possible values for the R, G and B color components with values from 0 to 255. A specific color in the model can be written as RGB[r, g, b]. Using this notation, black would be written as RGB[0, 0, 0], white would be written as RGB[255, 255, 255].

The classification method described by the former invention is limited in that it describes binary choices for the R, G, and B component: on or off. Once an event is classified with a primary color, it cannot be further classified using that color. For example, if an event has been painted with red, the operation of painting it with red in a different region would have no effect on its classification. In other words, once an event has been painted red, it cannot be painted MORE red. The classification of an event is, thus, the combination of a single bit of data for each of the primary color components.

The limitation of this methodology for classifying events is actually described in the prior art invention itself. That is, given the fact that there are inherently only 3 primary colors, and 2 possible values for those colors (on or off), only 7 distinct populations can be described using the methodology. In actuality, there are 2³=8 possible classification values of an event, as an event can have all of its color bits turned off.

For display purposes, the binary values for the R, G and B components get converted into the RGB Model as either 0, or 255. For example, as described in the previous invention, an event painted with red and green would have the color yellow. FIG. 2 shows the complete mapping of color bits to the RGB Color Model. Note that an event that has all of its color bits turned off would display as black using this model. In practice these events are displayed as grey so that they are visible against a black background.

No other method, other than the combining of colors in binary fashion, is described in the previous invention for displaying events. Further, no method is suggested that would overcome the inherent limitation of 3 primary colors (red, green and blue) on the number of possible classification values for event.

In order to classify more than 8 distinct populations, the inherent limitations of the former invention's method for classifying and displaying events must be overcome.

The only known example of the prior art invention in practice is the Paint-A-Gate software from Becton Dickinson and Company. Several versions of Paint-A-Gate have been released since 1989, but all of them use the exact methodology described above for the classification and display of multi-parameter data sets. No version of the Paint-A-Gate software has the capability to classify more than 8 distinct populations. It's a fundamental limitation that cannot be overcome with the methodology described in the prior art invention.

### SUMMARY OF INVENTION

### Color Levels

Ultimately all displayable colors are combinations of the 3 primary colors (red/green/blue). One way to overcome this fundamental limitation, and thus increase the number of possible classification values, would be to allow an event to be painted multiple times with the same primary color, and have this operation effect the classification value of the event. This concept of classifying events more than once with the same primary color did not exist in the prior art invention.

In this new classification methodology, we define an extended classification space that has a maximum COLOR LEVEL value of n. An event can be classified with 0 to n LEVELS of each primary color. For example, say the currently defined classification space has a maximum color level value of n=3, and we are painting with the primary color red. In this example, an event could be painted up to 3 times with red and its classification value would be different on each subsequent paint operation. Once the event had a red color level of 3, further paint operations with red would have no effect on the event's classification. The number of possible classification values for a given classification space would therefore be (n+1)³. In this example one could classify up to 4³=64 unique populations. There is no theoretical limit on the maximum color level value that can be defined for a classification space.

In this new classification space the classification value of an event is described as an array of 3 integers representing the color levels of the 3 primary color components. The classification value can be written in the form [r, g, b] where r is the number of red color levels of the event, g is the number of green levels, and b is the number of blue levels.

So the classification value for a given event is defined as:

| Red Color | Green Color | Blue Color | Classification |
|---|---|---|---|
| Levels | Levels | Levels | value |
| r | g | b | [r, g, b] |

where 0 <= r, g and b <= n (maximum color level).

While the use of Color Levels mathematically solves the classification limitation presented by the 3 primary color issue, it does not address problems of displaying events.

### Color Levels and the RGB Color Model

One possible solution for how to display events with n>1 color levels using the RGB model could be realized by interpreting the color level as a percentage of r,g,b values.

For the purpose of this example we will denote an RGB value in the form RGBPercent[r,g,b] where r,g and b can have a value from 0.0-1.0. For example, if the maximum color level is defined as n=5, one could assign the event 20% of a color on each paint operation. Let's suppose that an event starts out unclassified and is painted with red. Its RGB value would then be RGBPercent[0.2, 0.0, 0.0]. Let's suppose that the event is painted with red again: its RGB value would be

### RGBPercent[0.4, 0.0, 0.0], etc.

The problem with trying to map color level classification space directly to the RGB Color Model in this fashion is that the brightness of the resulting colors drop as the r,g,b percent values are reduced. This can make visualization of the events difficult against a black background. FIG. 3 shows how colors in the RGB color model become less bright as the percent values of the color components are reduced. In this figure the circles are filled with different percents of red.

This solution, while not ideal, is nonetheless a viable option for displaying events in multi-color level classification space, and is to be considered part of the this instant invention.

### Color Levels and the HSB Color Model

A better solution for displaying event colors where n>1 was realized by using a less obvious choice of color model: The HSB (Hue/Saturation/Brightness) Color Model.

Based on the human perception of color, the HSB model describes three fundamental characteristics of color (see FIG. 4).

Hue is the color reflected from or transmitted through an object. It is measured as a location on the standard color wheel, expressed as a degree between 0° and 360°. Red is located at 0° on the color wheel, green at 120° and blue at 240°.

Saturation is the strength or purity of the color. Saturation represents the amount of gray in proportion to the hue, measured as a percentage from 0% (gray) to 100% (fully saturated). On the standard color wheel, saturation increases from the center to the edge.

Brightness is the relative lightness or darkness of the color, usually measured as a percentage from 0% (black) to 100% (white).

The algorithm needed to calculate an event's color using this model is more complicated and less obvious than with the RGB Color Model. From a user's perspective the simple concept of combining colors to arrive at a final color is still desirable. But as has been shown, simply combining colors in RGB space produces unexpected and less than desired results. Although we will be calculating an event's color in HSB Color Space, it should appear to the user that colors are being combined in an intuitive fashion.

### BRIEF DESCRIPTION OF DRAWINGS

FIG. 1—The RGB Color Model

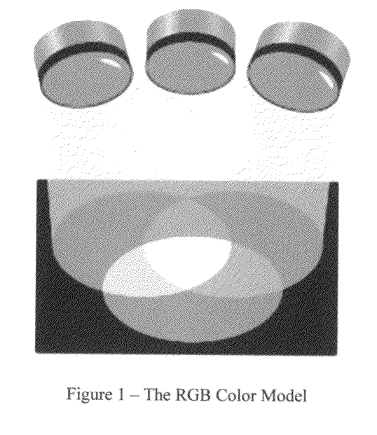

FIG. 2—Mapping Color Bits to the RGB Color Model in Prior Art Invention

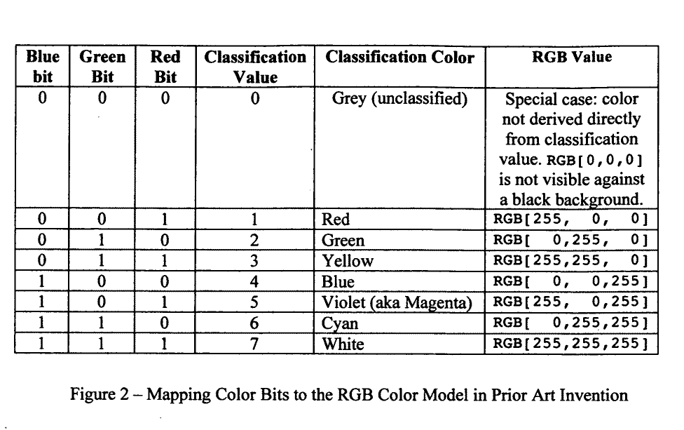

FIG. 3—Example of Drop in Brightness as RGB Component Values Decrease.

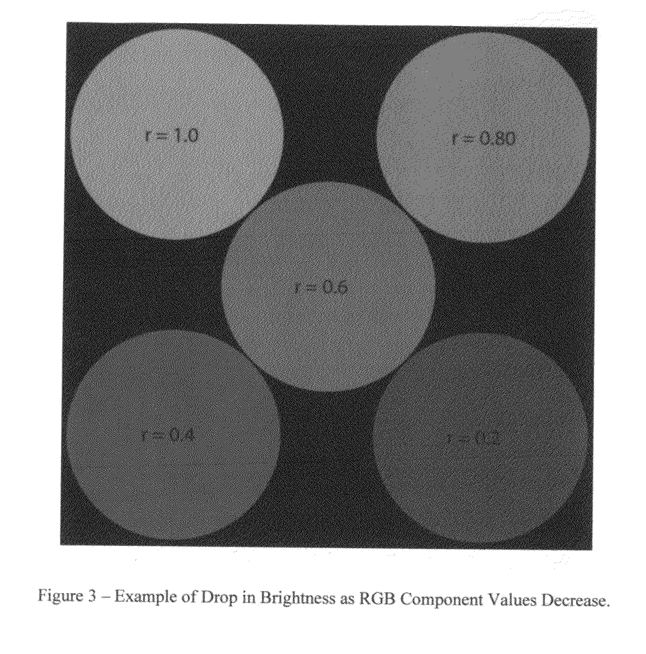

FIG. 4—Graphical Representation of the HSB Color Model

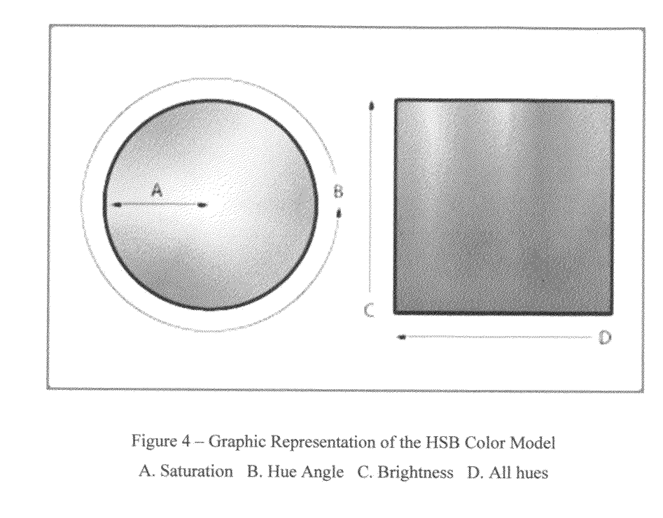

FIG. 5—Graphic: Mapping Classification Values to the HSB Color Model with Maximum Color Level n=1

FIG. 6—Table: Mapping classification values to the HSB Color Model with Maximum Color Level n=1

FIG. 7—Graphic: Mapping classification values to the HSB Color Model with Maximum Color Level n=2

### DESCRIPTION OF EMBODIMENTS

### Review

Before we can describe the algorithm, we should review some of the concepts of COLOR LEVELS.

An event has a classification value defined by the number of times it has been painted by the three primary colors R, G and B. The number of times an event has been painted with a given primary color is known as that color component's COLOR LEVEL. For example, if an event has been painted with red 3 times then its RED COLOR COMPONENT would have a COLOR LEVEL of 3.

The classification value can be written in the form [r, g, b] where r is the number of red color levels of the event, g is the number of green levels, and b is the number of blue levels.

The classification model has a maximum color level defined (n).

### Determining an Event's Color in HSB Color Space

Throughout this discussion the phrase “an event's highest color level” means the highest color level value from the event's classification value. For example, if an event's classification value is [0, 3, 2] then its highest color level is 3. The color component with the highest color level in this example is green.

Something to keep in mind is that, as a general rule, an event's display color moves toward white as the color levels increase. This will be explained later.

There are, in effect, three different equations that are used to calculate an event's color from its classification value. The equation that is invoked is determined by how many of the color components are at the highest color level.

1. All three colors have the highest color level (r=2=b)
1.1. The event's HSB value will have a SATURATION value of 0% (it will be some shade of grey). Because of this fact, the event's HUE value is irrelevant (it has no color).
1.2. The event's HSB value will have a BRIGHTNESS value determined by its highest color level value. If the highest COLOR LEVEL value is equal to the maximum value for the classification model (n) then the event will have BRIGHTNESS value of 100% (the event will be drawn as white). The BRIGHTNESS value is reduced as the highest color level goes down. The minimum BRIGHTNESS value will be set such that the event will be visible against a black background.
   2. Two colors have the highest color level
2.1. The event's HSB value will have a BRIGHTNESS value of 100%.
2.2. The event's HSB value will have a HUE ANGLE equal to the hue angle that falls between the color components with the highest color level (60° for red and green, 180° for green and blue, 300° for blue and red).
2.3. If the highest color level value is 1 then the event's HSB value will have a SATURATION value of 100%. As the highest color level increases, the SATURATION decreases (As an event's color levels increase, its display color moves toward white). In all cases the SATURATION value will be greater than 0.
2.4. If the color component with the lowest color level value has a color level greater than 0, the SATURATION value will be further reduced based on the lower color level value.
   3. One color has the highest color level
3.1. The event's HSB value will have a BRIGHTNESS value of 100%.
3.2. If the other 2 color components have the same color level.
   3.2.1. The event's HSB value will have a HUE ANGLE equal to the hue angle of the color component with the highest color level (0° for red, 120° for green, 240° for blue).
   3.2.2. If the highest color level value is 1 then the event's HSB value will have a SATURATION value of 100%. As the highest color level increases, the SATURATION decreases (As an event's color levels increase, its display color moves toward white). In all cases the SATURATION value will be greater than 0.
   3.2.3. The SATURATION value can be further reduced based on the color level of the 2 minor color components.
      3.3. If the other 2 color components have different color level values.
3.3.1. The HUE ANGLE will shift toward the color component with the next highest color level. The amount of the hue angle shift will be determined by the next highest color level value. The higher the color level value, the greater the hue angle shift to that color component's hue angle.
3.3.2. If the highest color level value is 1 then the HSB value will have a SATURATION value of 100%. As the maximum color level increases, the SATURATION decreases (As an event's color levels increase, its display color moves toward white). In all cases the SATURATION value will be greater than 0.
3.3.3. If the color component with the lowest color level value has a color level greater than 0.
   i. The SATURATION value may be lowered slightly based on the lowest color level value.
   ii. The HUE ANGLE may shift slightly toward the color component with the lowest color level value.

IMPORTANT NOTE: It is understood that an arbitrary choice has been made to reduce saturation as the highest color level increases. For the purposes of this instant invention it is an equally acceptable choice to increase saturation as the highest color level increases.

### EXAMPLES

### Example 1

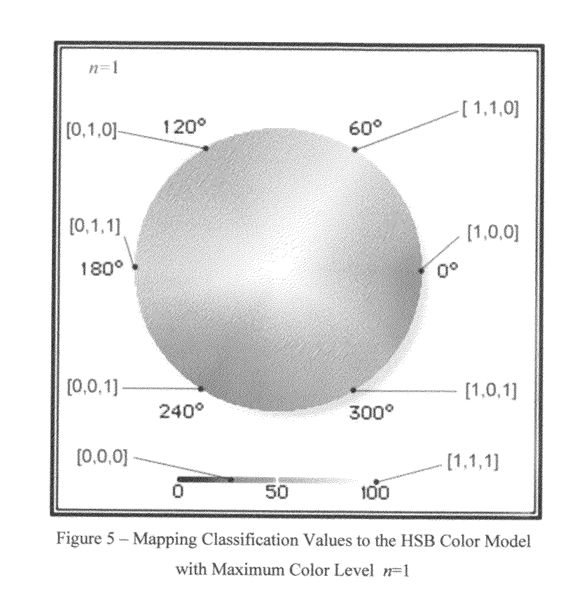

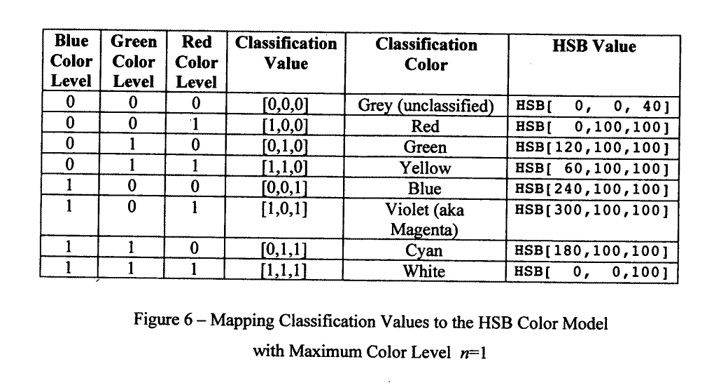

FIGS. 5 and 6 show how classification values are mapped to display colors where the Maximum Color Level for the classification space is n=1. It should be noted that although the algorithm used to calculate an event's color is completely different than that used in the current Paint-A-Gate software, the new algorithm returns the same results, making it backward compatible for the classification space with Maximum Color Level n=1.

### Example 2

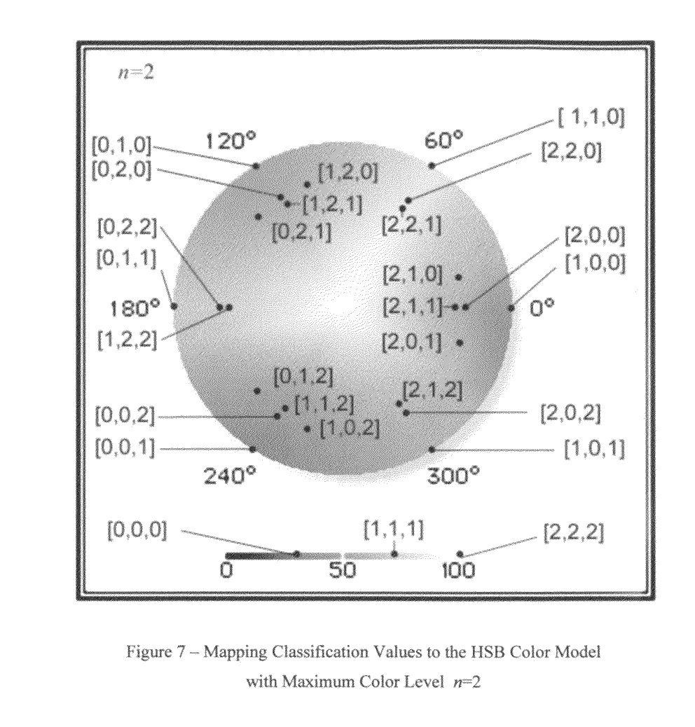

FIG. 7 shows how classification values are mapped to display colors where the Maximum Color Level for the classification space is n=2. Note that the saturation is lowered as the highest color level increases.

### INDUSTRIAL APPLICABILITY

The methods and techniques described herein are applicable generally to a wide variety of scientific and industrial data analyses. As an example, they directly apply to analysis of streams of particles, such as are gathered in cellular immunology using a flow cytometer—a medical device.

### CITATION LIST

U.S. Pat. No. 4,845,653 Conrad, et al Method of displaying multi-parameter data sets to aid in the analysis of data characteristics
U.S. Pat. No. 5,627,040, Bierre, et al. Flow cytometric method for autoclustering cells
U.S. Pat. No. 5,224,058, Mickaels, et al. Method for data transformation
U.S. Pat. No. 5,739,000, Bierre, et al. Algorithmic engine for automated N-dimensional subset analysis
U.S. Pat. No. 5,795,727, Bierre, et al. Gravitational attractor engine for adaptively autoclustering n-dimensional datastreams
U.S. Pat. No. 7,332,295 Multidimensional leukocyte differential analysis
U.S. Pat. No. 7,587,374, Lynch, et al. Data clustering method for bayesian data reduction
U.S. Pat. No. 6,868,342, Mutter Method and display for multivariate classification
U.S. Pat. No. 7,409,299, Schweitzer Method for identifying components of a mixture via spectral analysis
U.S. Pat. No. 7,401,056, Kam Method and apparatus for multivariable analysis of biological measurements
U.S. Pat. No. 7,522,768, Bhatti, et al. Capture and systematic use of expert color analysis
U.S. Pat. No. 6,178,382, Roederer, et al. Methods for analysis of large sets of multiparameter data

What is claimed is:

1. A system and method for analyzing multidimensional datasets into populations of related multidimensional data points (i.e., population analysis) consisting of:
a computer assisting a data analyst (i.e., user) with automated computations and decisions, by means of an algorithm taught herein;
a computer graphical user interface (GUI) allowing the user to interact with a plurality of plots of the data to apply knowledge to the task of classifying data points into populations, by means of a GUI mechanism taught herein, comprising:
a) a pointing device used to select a region of dots in a plot,
b) associated with the region selection is a primary color,
c) the effect of the region selection operation is to assign a color attribute to all data points falling within the selection region
d) color attribute of claim 1c is added to color attributes previously associated with each data point by means of claim 1c, the effect conveyed to the user by changing the display color of the point, giving the user the impression of having “painted” the points
e) after each such painting stroke, data points having precisely matched color attributes are clustered into a population, and the user can view summary population statistics (e.g., counts, frequencies, means, standard deviations) for the full set of populations so formed
f) in order to expand the number of distinct populations that may be formed and still seen as visually distinct, a plurality of painting strokes using the same primary color may be superimposed, having the effect of coloring of a data point in a predictable manner, an algorithmic embodiment of which is taught herein
g) the user may choose the maximum number of levels of superimposed primary color painting
h) at any desired stage of said painting operations, the user may elect to attach permanence to the classification method so defined, by “saving” the combined operation in a manner that may be applied later to classify a plurality of similar datasets.

2. The method of claim 1 where the plot of may be a two (2) dimensional plot depicting a choice of any two-measurement dimensions of the data

3. The method of claim 1 where the plot of may be a three (3) dimensional plot depicting a choice of any three-measurement dimensions of the data

4. The method of claim 1 where the plot of may be a histogram plot depicting a choice of one-measurement dimension of the data

5. The method of claim 1 where each dataset is materialized as a computer file or a real-time data stream

6. The method of claim 1h where the saved classification method is materialized as a file

7. The method of claim 1 where a batch of datasets may be automatically processed for classification using a plurality of the saved methods of claim 1h applied repetitively to said datasets

8. The method of claim 1 where the results of population analysis are saved in a standard importable file format

9. The method of claim 1 where the dataset is a multi-parameter event recording or data stream obtained in conjunction with cells passing through a flow cytometry instrument.

11. The method of claim 1b where the primary colors are red, green, and blue

12. The method of claim 1f where the predictable change in color effected by superimposing paint strokes is to change the color in hue-saturation-brightness (HSB) color model space, an algorithmic embodiment of which is taught herein

13. The method of claim 1f where the predictable change in color effected by superimposing paint strokes is to change the color in an RGB color model space, an algorithmic embodiment of which is taught herein
